(19) United States
(12) Patent Application Publication
(10) Pub. No.: US 2025/0078204 A1
(43) Pub. Date: Mar. 6, 2025

(54) SYSTEMS AND METHODS FOR UP-SCALING KERNEL RE-MAPPING IN THE CONVOLUTIONAL NEURAL NETWORKS AND EFFICIENT BLOCK-BASED CONVOLUTIONAL NEURAL NETWORK

(71) Applicant: META PLATFORMS, INC., Menlo Park, CA (US)

(72) Inventors: Xianliang Zha, El Dorado Hills, CA (US); Lei Feng, Sunnyvale, CA (US); Chien Cheng Liu, San Jose, CA (US); Harikrishna Madadi Reddy, San Jose, CA (US); Raghuvardhan Moola, Fremont, CA (US); Yunqing Chen, Los Altos, CA (US)

(21) Appl. No.: 18/460,975

(22) Filed: Sep. 5, 2023

(51) Int. Cl. G06T 3/40

(52) U.S. Cl. CPC G06T 3/4046

(57) ABSTRACT

The present application describes systems, methods, devices, and computer program products for convolutional neural networks (CNN) applicable for image processing, image scaling, and computer vision-oriented operations. Various embodiments for image scaling may receive image data corresponding to a first resolution. The image data may have a channel size and a data size. A CNN may be applied to process the image data according to a set of kernels. A first kernel set and a second kernel set may be independently applied to the image data to generate a first output set and a second output set. An interleaved set may be generated from the first output set and the second output set. An output image having a second data size may be generated from the output sets.

### TECHNICAL FIELD

The present application generally is directed to systems and methods for block-based convolutional neural networks (CNNs).

### BACKGROUND

CNNs are being used to solve a vast array of challenging machine learning problems. These may include, for example, natural language processing, computer vision and recommendation systems. CNNs are a very powerful tool in the fields of image processing and computer vision, and comprise a series of computation layers, where each layer takes the output of the preceding layer as its input. In so doing, CNNs may achieve extraordinary results with regard to image object recognition accuracy, object detection and classification. However, the trade-off for these results is high computational cost.

CNNs for video and image quality improvement, de-noise, super-resolution, and similar features traditionally utilize many different algorithms. Many of those algorithms often require the dedicated hardware circuits to support the specific and different functions which cannot be shared among these algorithms due to the cost and performance reasons. However, the trade-off for these results is high computational cost. Especially in dynamic environments, video and image quality features and related operations require significant computational resources.

Machine learning and inference provide a couple approaches to address computer-vision related quality features. In some examples, machine learning may be used to find the optimized kernels for each feature, and these kernels may be provided to the general-purpose CNN circuit to get the final solutions. But a general-purpose graphics processing unit (GPU) solution is, again, very costly and inefficient for Computer Vision (CV)-based CNNs.

Moreover, in conventional architectures, image and/or video data stored on an external memory are transmitted to and read by a CNN coupled to a processor either on a server or consumer product. The received image and/or video data is fed to a first layer of a block of a CNN. An output of the first layer is written back to the external memory. Back and forth reading-writing between the external memory and the CNN coupled to the processor continues until every layer in a block of the CNN has been processed. The processing power and signal bandwidth costs associated with conventional architectures may be extraordinarily high. Additionally, conventional architectures employing these techniques may take significantly longer to complete the processing of a single block of a CNN having many layers.

What is desired in the art is a more efficient and cost-effective architecture to handle communications between an external memory and a system on a server or consumer product.

### A. Systems and Methods for Up-Scaling Kernel Re-Mapping in the Convolutional Neural Networks

### BRIEF SUMMARY

One aspect of the application at least describes block-based CNN systems, methods, and devices. Various aspects may enable image scaling, such as up-scaling, down-scaling, frame rate conversions, and the like. Another aspect of the application at least describes an apparatus including a non-transitory memory including stored instructions for implementing the various methods discussed herein. The apparatus may also include a processor operably coupled to the non-transitory memory that is configured to execute the stored instructions.

An example system may include a pre-processing module, a convolutional neural network, a post-processing module, and a control module. The pre-processing module may receive initial image data and convert the initial image data to a first format. The CNN may receive the initial image data in the first format from the pre-processing module and convolution parameters from the pre-loaded or dedicated buffer. In some examples, the convolutional neural network processes the initial image data according to the convolution parameters to generate an output layer comprising processed image data, which may be scaled image data. The post-processing module may convert the processed image data to output packets, which may be provided to an external memory. The control module may manage communications between the pre-processing module, the convolutional neural network, the circular buffer, and the post-processing module.

In some examples, the pre-processing module may convert the initial image data to the first format by performing a color space conversion to convert image data from a first color space to a second color space. In some examples, the first color space is RGB, YUV, HSL, or CMYK, and the second color space is a different color space.

The pre-processing module may convert the initial image data to the first format by performing chroma up-sampling or down-sampling. According to some examples, the first format is RGB.

The convolutional neural network may further include a Rectified Linear Unit (ReLU) circuit to produce the output layer. In various examples, a ReLU activation function may be defined as f(x)=max (0, x), and include several layers to compute a weighted sum of inputs, which may be applied to the activation function, and subsequently used as inputs in a next layer. In some examples, the ReLU circuit may receive ReLU parameters from a buffer in the CNN. During processing operations, the CNN may run a plurality of iterations and produce a plurality of layers before the output layer. In some examples, the CNN further comprises a mux unit to combine the initial image data and the convolution parameters. The convolution parameters may include kernel parameters associated with a scaling operation, such as up-scaling, down-scaling, frame rate conversions, noise reductions, and the like. The CNN may further receive, via the mux unit, kernel parameters from a kernel buffer.

The post-processing module may apply at least one of a color space conversion, up-scaling, or down-scaling. The color space conversion may be based on parameters defined by an external memory. In examples, the post-processing module transfers the output packets to at least one external memory.

The processed image data may also be indicative of a frame rate conversion from the initial image data. For example, the initial image data may be indicative of a first frame rate, and the processed image data is indicative of a second frame rate. In some examples, the first frame rate is less than the second frame rate.

Efficient, block-based CNNs are also described herein. In one aspect, a method may include representing data as a first matrix including a plurality of elements and having M rows and N columns, where M and N are more than or equal to one; retrieving, by a CNN, a first element of the plurality of elements; processing sequentially, by the first layer of the plurality of layers and a remaining number of layers of the plurality of layers, the first element of the plurality of elements; retrieving, by the CNN, a second element of the plurality of elements; processing consecutively, by the first layer of the plurality of layers and the remaining number of layers of the plurality of layers, the second element of the plurality of elements; and outputting, via the CNN, a rendered representation of the data comprising the processed first element and the processed second element.

In another aspect, an example system may include a pre-processing module, a convolutional neural network, a post-processing module, and a control module. The pre-processing module may receive initial image data and convert the initial image data to a first format. The CNN may receive the initial image data in the first format from the pre-processing module and convolution parameters from the pre-loaded or dedicated buffer. In some examples, the convolutional neural network processes the initial image data according to the convolution parameters to generate an output layer comprising processed image data, which may be scaled image data. The post-processing module may convert the processed image data to output packets, which may be provided to an external memory. The control module may manage communications between the pre-processing module, the convolutional neural network, the circular buffer, and the post-processing module.

In some examples, the pre-processing module may convert the initial image data to the first format by performing a color space conversion to convert image data from a first color space to a second color space. In some examples, the first color space is RGB, YUV, HSL, or CMYK, and the second color space is a different color space.

The pre-processing module may convert the initial image data to the first format by performing chroma up-sampling or down-sampling. According to some examples, the first format is RGB.

The convolutional neural network may further include a Rectified Linear Unit (ReLU) circuit to produce the output layer. In various examples, a ReLU activation function may be defined as f(x)=max (0, x), and include several layers to compute a weighted sum of inputs, which may be applied to the activation function, and subsequently used as inputs in a next layer. In some examples, the ReLU circuit may receive ReLU parameters from a buffer in the CNN. During processing operations, the CNN may run a plurality of iterations and produce a plurality of layers before the output layer. In some examples, the CNN further comprises a mux unit to combine the initial image data and the convolution parameters. The convolution parameters may include kernel parameters associated with a scaling operation, such as up-scaling, down-scaling, frame rate conversions, noise reductions, and the like. The CNN may further receive, via the mux unit, kernel parameters from a kernel buffer.

The post-processing module may apply at least one of a color space conversion, up-scaling, or down-scaling. The color space conversion may be based on parameters defined by an external memory. In examples, the post-processing module transfers the output packets to at least one external memory.

The processed image data may also be indicative of a frame rate conversion from the initial image data. For example, the initial image data may be indicative of a first frame rate, and the processed image data is indicative of a second frame rate. In some examples, the first frame rate is less than the second frame rate.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The summary, as well as the following detailed description, is further understood when read in conjunction with the appended drawings. For the purpose of illustrating the disclosed subject matter, the drawings depict example embodiments of the disclosed subject matter. However, the disclosed subject matter is not limited to the specific methods and devices disclosed. In addition, the drawings are not necessarily drawn to scale. In the drawings:

FIG. 1A illustrates a communication system in accordance with the present application.

FIG. 1B illustrates a machine learning architecture in accordance with the present application.

FIG. 2 illustrates an example node in accordance with the present application.

FIG. 3 illustrates a block diagram of an example computing system in accordance with the present application.

FIG. 4 illustrate an example flowchart in accordance with the present application.

FIG. 5 illustrates an example embodiment of the present application.

FIG. 6 illustrates an example pre-processing module in accordance of the present application.

FIG. 7 illustrates in an example CNN core in accordance of the present application.

FIG. 8 illustrates in an example post-processing module accordance of the present application.

FIG. 9 illustrates an example control module in accordance of the present application.

FIG. 10 illustrates example output sets in accordance of the present application.

FIG. 11 illustrates example converted sets in accordance of the present application.

FIG. 12 illustrates an example indexing arrangement in accordance of the present application.

FIG. 13 illustrates a reordering example in accordance of the present application.

FIG. 14 illustrates an example reconfigured kernel in accordance of the present application.

FIG. 15 illustrates an example CNN according to the present disclosure.

FIG. 16 illustrates a data set and circular buffer according to the present disclosure.

FIG. 17 illustrates a process according to the present disclosure.

FIG. 18 illustrates a process according to the present disclosure.

The figures depict various embodiments for purposes of illustration only. One skilled in the art will readily recognize from the following discussion that alternative embodiments of the architectures and methods illustrated herein may be employed without departing from the principles described herein.

### DETAILED DESCRIPTION

Some embodiments of the present disclosure will now be described more fully hereinafter with reference to the accompanying drawings, in which some, but not all embodiments of the disclosure are shown. Indeed, various embodiments of the disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the disclosure. Moreover, the term “exemplary,” as used herein, is not provided to convey any qualitative assessment, but instead merely to convey an illustration of an example. Thus, use of any such terms should not be taken to limit the spirit and scope of embodiments of the present application. It is to be understood that the methods and systems described herein are not limited to specific methods, specific components, or to particular implementations.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

Aspects of the present disclosure provide a customized CNN system providing an efficient, customized end-to-end solution. Examples include customized CNN circuit designs providing high performance while using less power and less memory bandwidth than traditional CNNs. It will be understood the methods and apparatuses described in the present application may allow for an elegant solution to minimize processing power and reduce costs associated with multiple back and forth communication between an external memory, a CNN and a processor.

The CNN systems, methods, and devices discussed herein provide significant improvements and efficiencies for image quality improvement, noise reduction operations, and resolution improvements, among others. Rather than executing a routine set of operations for disparate features, and manual analysis, the present disclosure provides real-time, energy-efficient techniques to optimize image operations. For example, the machine learning techniques discussed herein enable optimal kernels to be determined and applied to an image, and generate customized and computationally-efficient scaling operations.

The block-based design of the CNN system efficiently distributes operations to respective processing entities, e.g., pre-processing module, control module, CNN core, and the post-processing module. This unique CNN circuit design results in less power, less memory bandwidth, and higher performance, compared to traditional CNNs. It further eliminates the needs for dedicated circuits for each unique processing operation.

Moreover, the CNN systems provided herein enable dynamic operation and functional testing in a live environment, thereby providing recognition, responses, and solutions to operational and functional issues that may not be recognized or caught during traditional static testing and implementations. In particular, the example systems, methods, devices, and computer program products enable real-time adaptation to dynamically changing environments. Each dedicated system block targets specific functions, while the control module ensures efficient communication and processing between the modules. For example, the CNN core, with its dedicated buffers (e.g., internal, in-place circular buffers), enables specific and customized kernel parameters to be defined, based on the desired scaling operation. The ReLU circuit is further designed to feed layer result(s) back to the in-place circular buffers for additional layer processing, or feed into the post-processing module, where the image information may be delivered, in a desired format, to an output device, such as an external memory.

Previous techniques often required manual testing and/or development of specific tests to process certain image types or color spaces, or to examine and determine various image scaling aspects, such as optimal kernel parameters. However, the present invention provides improved techniques, which may include an automated and/or machine learning-based, comprehensive implementations to analyze image types, color spaces, scaling operations, conversions, and provide dedicated operations to efficiently process each image and standardize operations. The examples and techniques discussed herein significantly improve upon traditional manual or “checklist” based methods, instead analyzing updates from a dynamic, live, and real-time perspective. Such techniques further enable customization and optimization, which may be difficult using traditional methods. In particular, specific dimensions and characteristics may be weighted and/or considered in the dynamic testing and operation techniques.

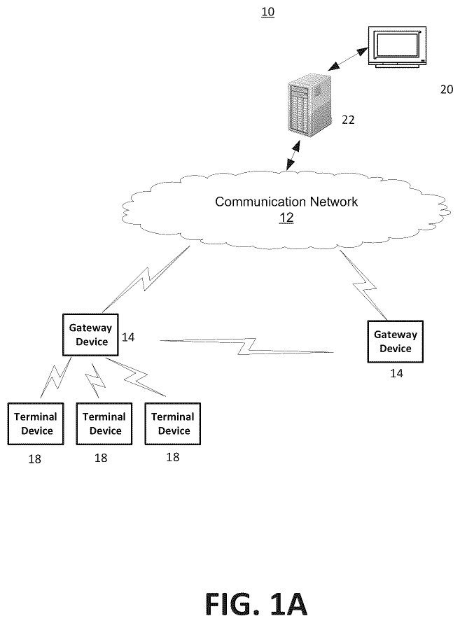

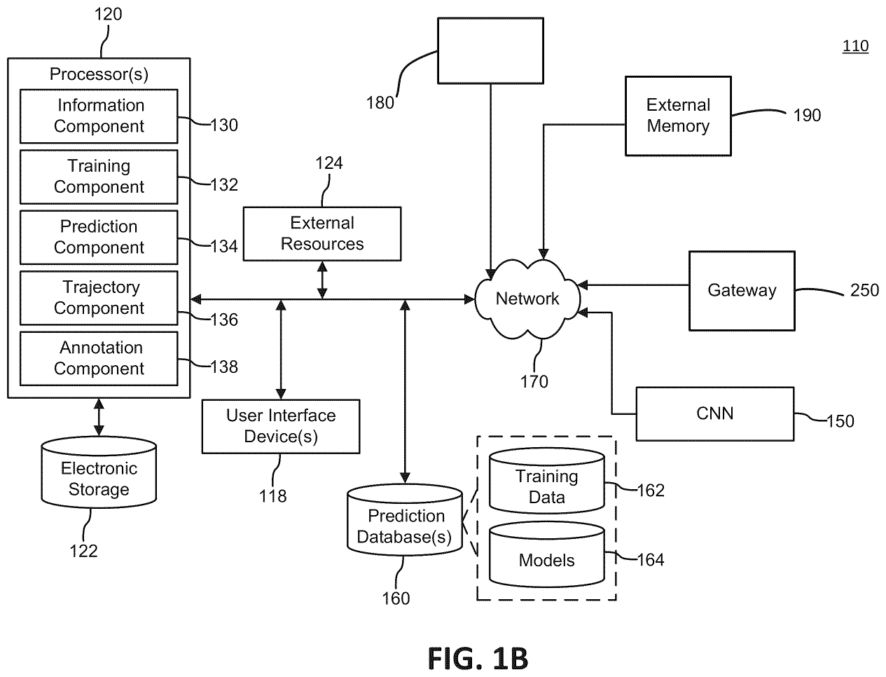

FIG. 1A is a diagram of an example communication system 10 in which one or more disclosed embodiments may be implemented. As shown in FIG. 1, the communication system 10 includes a communication network 12. The communication network 12 may be a fixed network, e.g., Ethernet, Fiber, ISDN, PLC, or the like or a wireless network, e.g., WLAN, cellular, or the like, or a network of heterogeneous networks. For example, the communication network 12 may comprise other networks such as a core network, the Internet, a sensor network, an industrial control network, a personal area network, a fused personal network, a satellite network, a home network, or an enterprise network for example.

It will be appreciated that any number of gateway devices 14 and terminal devices 18 may be included in the communication system 10 as desired. Each of the gateway devices 14 and terminal devices 18 are configured to transmit and receive signals via the communication network 12 or direct radio link. The gateway device 14 allows wireless devices, e.g., cellular and non-cellular as well as fixed network devices, e.g., PLC, to communicate either through operator networks, such as the communication network 12 or direct radio link. For example, the devices 18 may collect data and send the data, via the communication network 12 or direct radio link, to an application 20 or devices 18. Further, data and signals may be sent to and received from the application 20 via a service Layer 22, as described below. In one embodiment, the service Layer 22 may be a PCE. Devices 18 and gateways 14 may communicate via various networks including, cellular, WLAN, WPAN, e.g., Zigbee, 6LoWPAN, Bluetooth, direct radio link, and wireline for example.

According to an aspect of the present application, the architecture may include machine learning architecture, as illustrated in FIG. 1B. In one embodiment, the architecture may reside at a server. Alternatively, the architecture may reside on a consumer product or device, such as a computer system. More specifically, the architecture may include a processor operably coupled to one or more databases that may include the CNN. In an embodiment, the processor may be reference indicator 120 in FIG. 1B. The CNN may be reference indicator 150 as depicted in FIG. 1B. The CNN may include one or more blocks. Each of the one or more blocks may include, for example, at least one of: an information component 130, a training component 132, a prediction component 134, a trajectory component 136, or an annotation component 138. The processors may be in communication with electronic storage 122, external resources 124, user interface device(s) 118, prediction database(s) 160, which may include training data 162 and/or models 164. The processors 120 may also be in network communication with one or more external memories 190, gateway devices 250, or CNNs 150.

According to an embodiment, data may be located in an external memory, such as for example, a DDR memory. The data may include any one or more of image data or video data. In an example, the data may include pixels. In an example, the external memory may be depicted as reference indicator 190 in FIG. 1B. External memory 190 may communicate with the system including the processor 120 and CNN 150 via network 170.

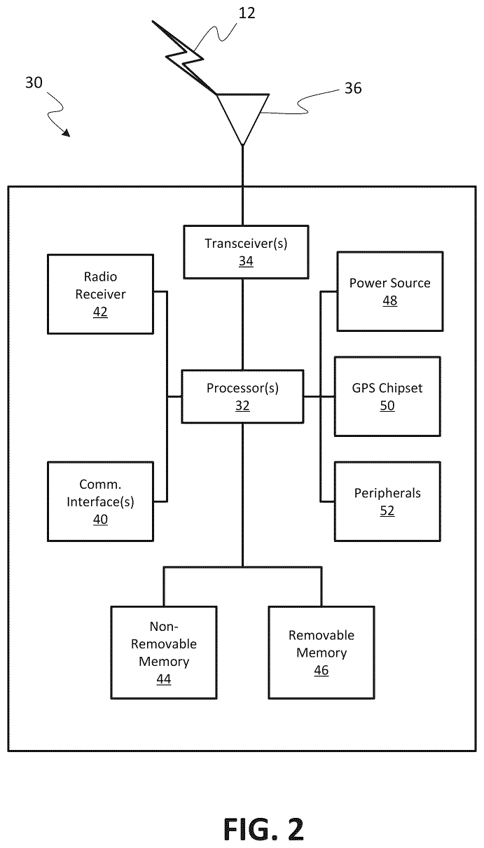

FIG. 2 illustrates a block diagram of an exemplary hardware/software architecture of user equipment (UE) 30. The architecture may be used in conjunction with the system depicted in FIG. 1. As shown in FIG. 2, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an exemplary embodiment, the camera 54 is a smart camera configured to sense images appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-Layer programs (e.g., browsers) and/or radio access-Layer (RAN) programs and/or other communications programs. The processor 32 may also perform security operations such as authentication, security key agreement, and/or cryptographic operations, such as at the access-Layer and/or application Layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

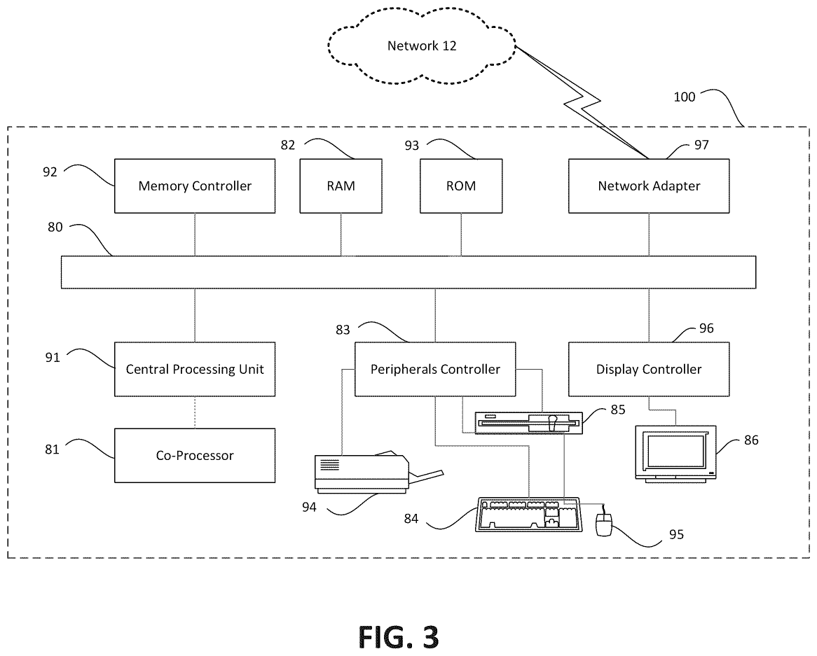

FIG. 3 is a block diagram of an exemplary computing system 100 which may also be used to implement components of the system or be part of the UE 30. The computing system 100 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 100 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 100 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 100 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 100. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 100 may contain communication circuitry, such as for example a network adaptor 97, that may be used to connect computing system 100 to an external communications network, such as network 12, to enable the computing system 100 to communicate with other nodes (e.g., UE 30) of the network.

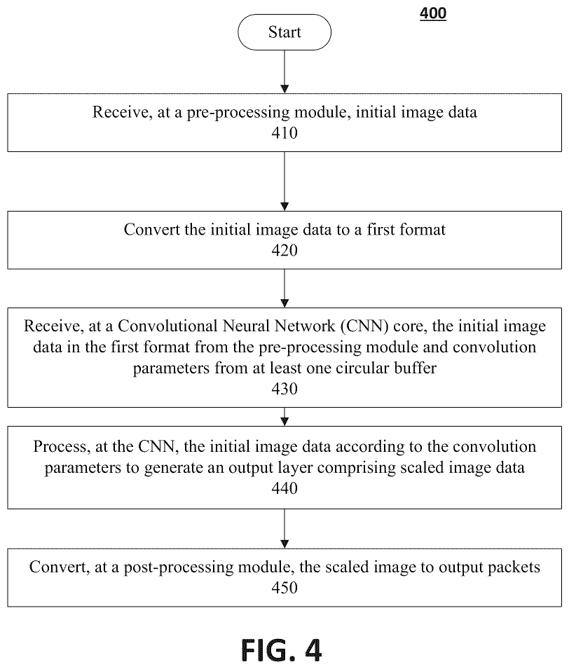

According to an aspect of this application FIG. 4 illustrates a flowchart of an example process 400. In some implementations, one or more process blocks of FIG. 4 may be performed by a device (e.g., UE 30, computing system 100). The example process 400 may be an image operation, including but not limited to a scaling operation (e.g., up-scaling, down-scaling), a resizing operation, a noise reduction operation, or a resolution improvement operation, among other operations.

As shown in FIG. 4, block 410 may include receiving, at a pre-processing module, initial image data. Such initial image data may be raw image data, pre-processed image data, data in a first color space, and the like. For example, initial image data may be in a color space including but limited to RGB, YUV, HSL, or CMYK.

At block 420, the pre-processing module may convert the initial image data to a first format. The first format may be a particular color space, such as converting the image data to RGB. In some examples, the initial image data may go through color space conversion and/or chroma up-sampling. For example, Chromo420 data may go through up-sampling to Chroma44, or Chroma444 data may go through color space conversion, e.g., to RGB444. Blocks 410 and 420 may be optional, and various aspects include one or both operations.

At block 430, a convolutional neural network core module may receive the initial image data in the first format from the pre-processing module or the previous layer result from one of the circular buffers, and convolution parameters from the kernel buffer which has the pre-loaded parameters for each CNN layer process. The CNN core may include one or more in-place internal circular buffer. These may include, but are not limited to, and aux circular buffer, a main circular buffer, a kernel buffer, and a buffer for ReLU parameters. In some examples, the internal circular buffers may feed data into convolution circuit and layer adder to manage optimization operations. The buffers may include temporary buffers and/or serve as a location where a layer output may be saved.

A multiplexer, i.e., mux unit, may receive the initial image data, previous layer result, and parameters from one or more buffers. In some examples, the multiplexer may be managed, at least in part, by the control module. Such data may then be fed into the convolution circuit to process the input image data (the initial image or the previous layer result) and determine the next layer.

At block 440, the CNN may process the input image data according to the convolution parameters to generate an output layer comprising processed image data. The convolution parameters may include kernel parameters associated with a scaling operation and may be determined based on at least one machine learning module, which may be external or internal the CNN core module. The result image can be fed back into the circular buffer or transmitted into the post-process unit.

At block 450, at a post-processing module, the scaled image may be converted to output packets. The output packets may optionally be provided to an external device, such as an external memory. In various examples, the output packet format may be customized, e.g., depending on where they are to be delivered.

Accordingly, the discussed systems and methods may provide video and image scaling, frame rate conversions, noise reductions, and other image operations. For example, a video may be converted from 30 frames per second (fps) to 60 fps. In another example, a video may be converted from 120 fps down to 60 fps.

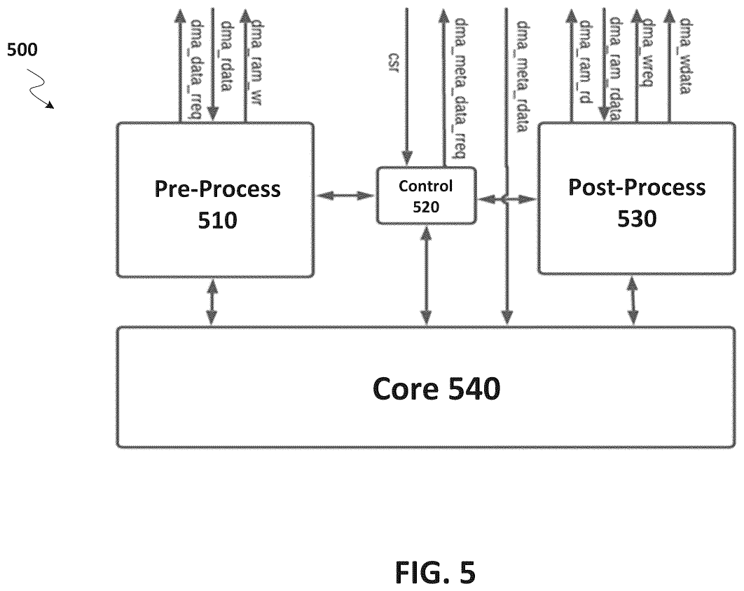

To further explain the concepts described above, the embodiment depicted in FIG. 5 shows a block-based CNN system architecture. The CNN system may include a Pre-Processing block 510, a CNN Core 540, a Post-Processing block 530, and a Control block 520. The CNN system architecture 500 and its blocked design significantly reduces system bandwidth and power compared to traditional convolutional neural network arrangements.

In various examples, at least one in-place circular buffer may be included and configured to make left-neighbor data and input data into a continuous data space. Instruction-based operations enable the internal in-place circular buffer to function similarly to general purpose registers of a CPU and give firmware or drivers full control of the buffer.

As further discussed herein, the Pre-Process module 510 and Post-Process module 530 may enable up-sampling of images, from end-to-end, to obtain a high quality vision effect. In addition, kernels, such as a super-resolution kernel re-configuration reduces Depth-to-Space conversions with power and performance improvements.

The Pre-Process block 510 may handle input channel data reads, chroma up-sampling, color space conversion, and first layer data buffer management.

The Core block 540 primarily processes layer convolutions, ReLU, layer copies, layer adds, intermediate layer data buffer management, and meta data management. Metadata may include, but is not limited to kernel and ReLU data.

The Control block 520 may communicate with each of the other blocks-Pre-Process 510, Core 540, and Post-Process 530—with the pre-generated different control signals for the different pipeline stages to orchestrate communications between and operations of the other systems for seamless operation and integration.

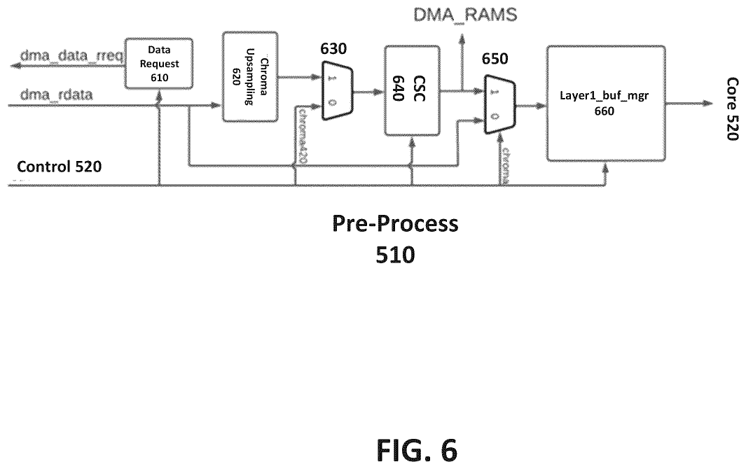

FIG. 6 provides an example architecture of the pre-process block. According to various aspects data request 610 may receive block level parameters from the control block 520, and generate a request to a memory, e.g., Direct Memory Access (DMA). Read data returned from the memory (e.g., referred to herein as DMA) may feed into one of three modules: Chroma Up-sampling 620, Color Space Conversion 640, or layer1_buf_mgr 660—based on the input data formats.

In a first example, read data including Chroma420 data may go to the Chroma Up-Sampling module 620. The Up-Sampling module 620 may convert chroma420 data to chroma444. From there, a verification 630 may determine whether data may be passed to the CSC. In another example, up-sampled chroma 444 data may pass through verification 630 and to the CSC 640. Chroma420 data may be prevented from being passed to the CSC 640.

In yet another example, read data including Chroma444 data may go to the Color Space Conversion (CSC) module 640. The CSC may convert Chroma444 to RGB444 into the DMA-shared buffer. In some examples, this may occur if output needs to add back source RGB data. As mentioned above, the CSC 640 may receive data up-sampled from the up-sampling module 620 or directly from the input, and further convert the up-sampled data, e.g., to RGB. In some examples, input/output CSC format conversion may be supported when the input is in RGB or Y formats. The CSC 640 may also support down-scaling or even no-scaling. According to some aspects, a no source add back may be supported, especially when the ADD input from MUX is zero.

In a third example, read data including RGB data may go to a buffer manager, e.g., layer1_buf_mgr 660. Layer1_buf_mgr 660 may also receive data from the CSC 640, once it has passed a verification 650, similar to block 630, to ensure it is in an acceptable format. For example, verification 650 may receive chroma data directly from the control block 520. Layer1_buf_mgr 660 may maintain a block level left column and top line buffer and combine input data with top and left buffer to form input data to directly feed core 540.

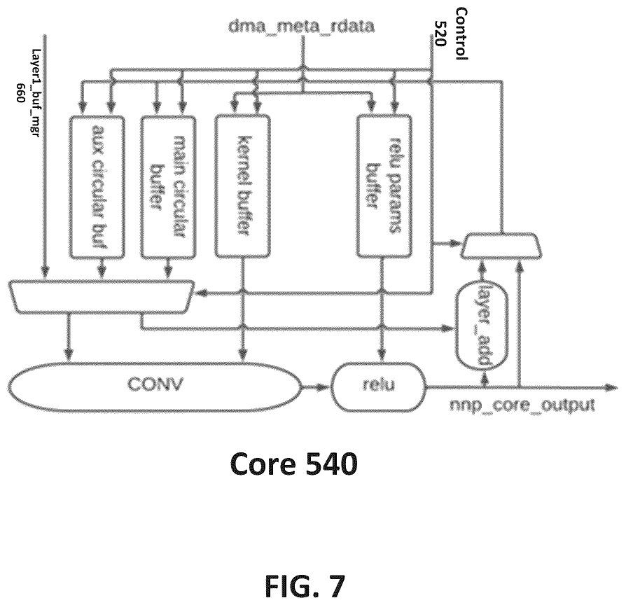

FIG. 7 illustrates an example architecture for the CNN Core 540. The core 540 may accept metadata from the DMA (e.g., dma_meta_rdata), and may write the data into a kernel and ReLU buffer, e.g., for CNN operations. Internal, in-place circular buffers and meta buffers may be applied and controlled by Control module 520. Such buffers may include an aux circular buffer, a main circular buffer, a kernel buffer, and ReLU parameter buffer.

Control information may be used to select data from at least one of a layer1_input, or one or two internal circular buffers, such as the aux buffer and/or main circular buffer. The selected control data may then be fed into the convolution circuit (CONV) and layer adder.

The convolution circuit may receive input data from a multiplexer/mux unit, for example, and may receive kernel parameters from a kernel buffer. Convolution results may then be fed into the ReLU circuit. ReLU parameters may also be fed into the ReLU circuit. The ReLU circuit, along with any special functions (e.g., from ReLU params buffer), may produce a layer result. The layer result may be fed back to the in-place circular buffer, e.g., for the next layer (see, e.g., layer_add), or sent to the Post-Process block 530 if the layer result is the final layer.

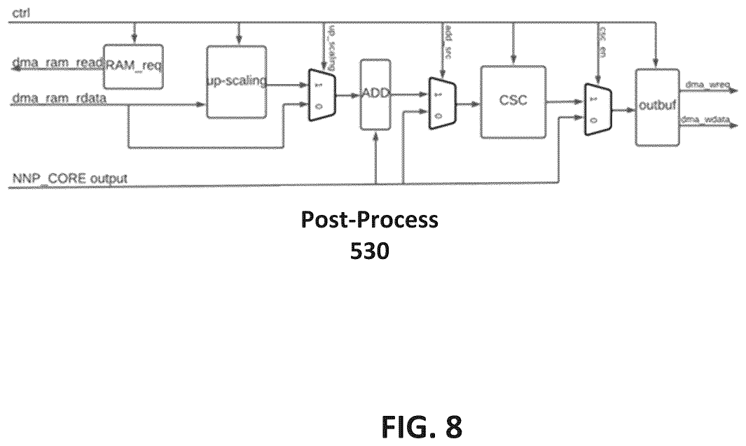

FIG. 8 illustrates the Post-Process architecture 530. A RAM_req module may request block level signals from Control 520 to generate dma_ram_read, which reads source RGB data as needed. As discussed above, at Pre-Process 510, image data may be up-scaled to RGB. DMA_ram_rdata feeds into an up-scaling module, which generates up-scaling output in the raster order to match the core output.

The ADD block can add the core output with source RGB data from mux logic to pick up-scaling data or non-scaling data. The CDC may perform color space conversion from RGB444 to chroma444, then from chroma444 to chroma420. The CSC input from the mux logic may directly provide the output from the Core output and/or the result from the ADD circuit. Accordingly, outbuf provides global output parameters from control 520, and receives output data from the CSC and/or the core 540 to form output packets to DMA.

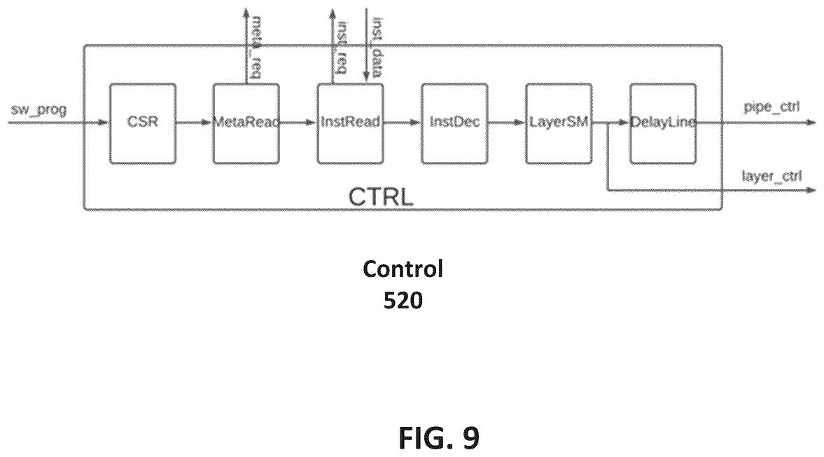

FIG. 9 illustrates an example architecture of Control 520. As discussed herein, the control block 520 enables seamless communication and integration between the Pre-Process, Post-Process, and Core blocks. At the Control block, a software program's global parameters passes through the CSR block and serves to prepare all other metadata in the memory. The MetaRead block responds to the CSR block to send metadata read requests, as needed. The metadata read return may go directly to metadata buffer of Core 540.

Once the MetaRead setup cycle is complete, InstRead module may request and receive instructions. For example, InstRead may send instruction read requests to stream in block-based through the DMA. In some examples, such read requests occur if InstRead has the buffer to receive additional instructions. As long as instructions are available, the InstDec block may decode the instructions for hardware execution.

When decoded instructions are available for a block layer to run, LayerSM will start and send the layer level and pipeline level control signals to coordinate other Core systems to run.

The DelayLine block may provide a phase alignment process. For example, once pipeline level control signals are generated, such control signals pass through the DelayLine block to perform phase alignment. Aligned pipeline control signals may then be sent to other blocks and modules to complete CNN operations at the different pipeline stages.

### Up-Scaling Kernel Remapping

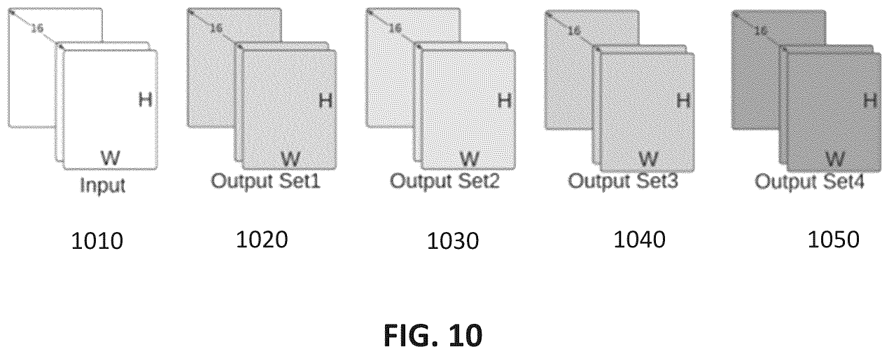

As discussed herein, the convolutional neural network (see, e.g., FIGS. 5-9) is a very powerful tool in the fields of image processing and computer vision. One powerful application of the CNN is Super-Resolution, which may scale up an image from low-resolution into high-resolution in multiples of the original image size. FIGS. 10, 11, 12, 13 and 14 provide example systems and methods to perform Super-Resolution and up-scaling kernel remapping, which may be applicable with CNN systems, such as the block-based architecture discussed herein.

One powerful usage of CNNs is Super-Resolution, which is often used to scale up an image from low-resolution into high-resolution in multiples of the original image size. A common scale factor for super resolution is two. In other words, an original image may be scaled up twice its original resolution.

In a first example, using the common case of a scale factor of two, a software solution on the frame-level or block level may apply a CNN to the same block four times, with different kernels, to get four interleaved blocks. A depth to space conversion is typically performed on the interleaved blocks to get a final scaled image or block. However, this approach is inefficient in hardware solutions.

To address these inefficiencies, the following systems, methods, and devices present a circuit solution to apply the CNN to the same block, with the different kernels, to get a scaled block in place without depth to space conversion. As a result, the design is simpler, and performance improvement and power saving benefits may be realized.

FIGS. 10, 11, 12, 13 and 14 illustrate this approach on an exemplary 16-channel input. FIG. 10 illustrates a 16-channel input, and four 16-channel outputs. The 16-channel input is provided in the CNN, and 16 channels are provided as CNN output, with 3×3 kernels. In various examples the channel size may be more or less than 16 channels, and the data size may be W×H. In some examples, the CNN core may process a 4×4 data size for the input channels and generate 2×2 data size for output channels.

According to various embodiments upscale an image, for example to scaling an image by 2×, the CNN may apply a plurality of different CNN sets. In an example there are four CNN sets, and each set may have 16×16×3×3 kernels. This may result in in 64×16×3×3 kernels for the same input channels, and each output set may generate the same output size as W×H. For example, 4 output sets will form 2 W×2 H output after a depth-to-space operation.

In this example, after applying each kernel set to input data, four output sets (e.g., output sets 1020, 1030, 1040, 1050) may be generated as shown in FIG. 10. With depth-to-space conversion, a final 2× scaling output may be generated.

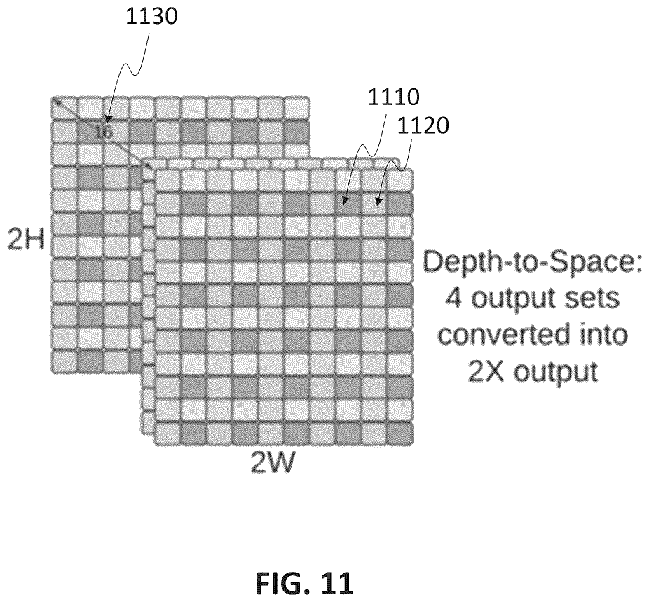

FIG. 11 shows how, in various examples, each output set result is not continuous. In other words, the same color data sets 1110, 1120 are not adjacent. Traditionally, memory write operations are neither convenient nor efficient, and depth-to-space operations need a local buffer which is costly.

Therefore, to eliminate the depth-to-space conversion, the input kernel sets can be re-configured to service the goal. In an example, the CNN core may process a 16×16×3×3 convolution to a 4×4 input data size. Each set kernel may be divided by an input channel number 1130. In FIG. 11, the input channel number 1130 is 16. Accordingly, each set may have 16 groups with the index from S0 to S15, then combine the group with the set index from the different sets to form a new set.

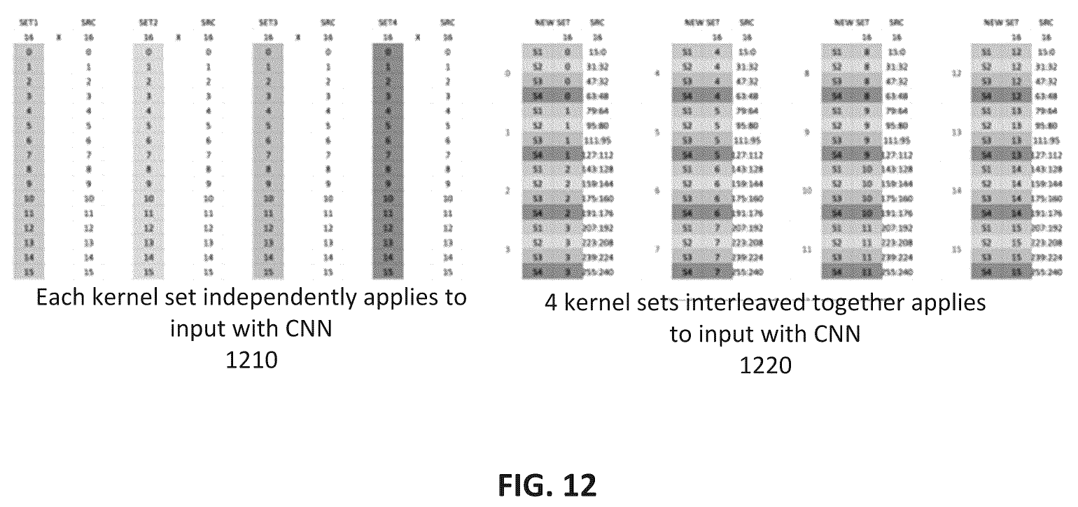

FIGS. 12, 13, and 14 show that each index in the red color stands for data in the adjacent 2×2 for as the right one. As illustrated in FIG. 12, each kernel set may be independently applied to the input data using the CNN 1210. The kernel sets may then be interleaved together 1220. In other words, grouping 1210 may refer to the per kernel set configuration, and grouping 1220 may refer to the input kernel results.

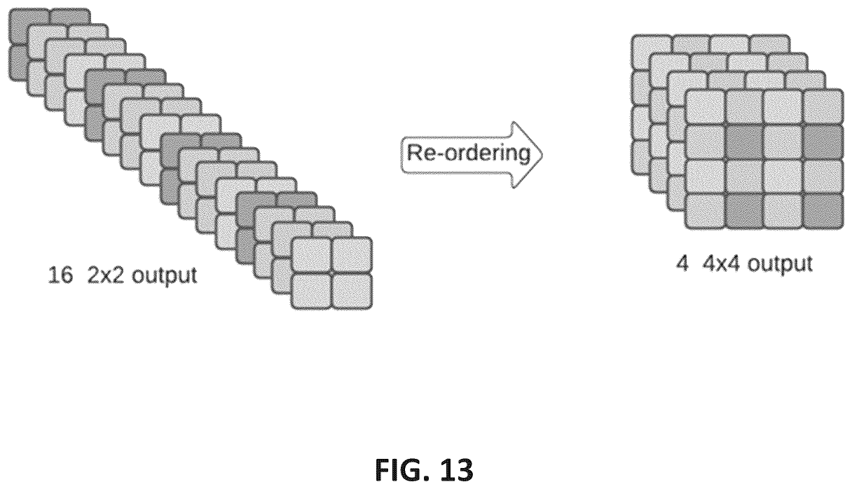

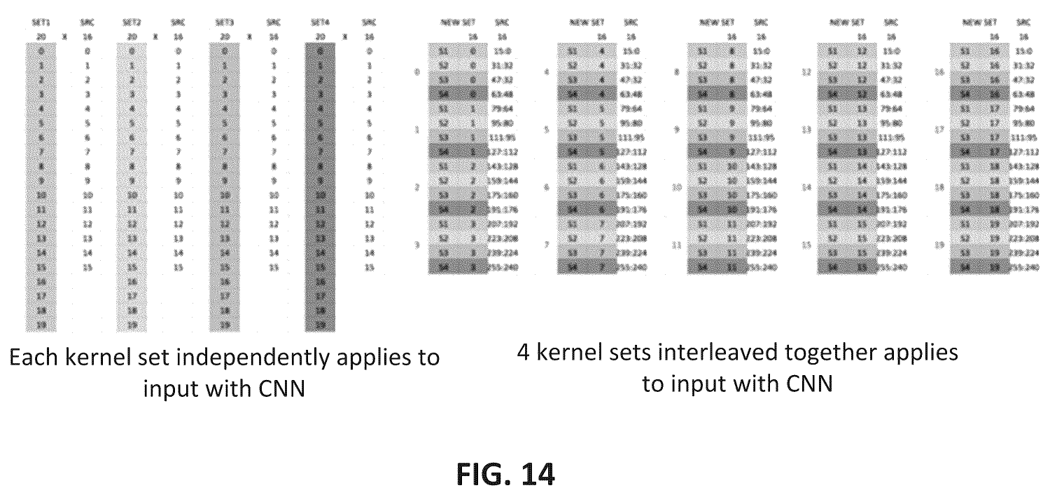

FIG. 13 illustrates a reordering operating, reducing 16 2×2 outputs to 4 4×4 outputs. In such operations, the memory operation may become much more efficient when reordering after the kernel is re-configured. Another advantage of reordering is to improve performance when output channel number may not be aligned with the output channel processed by the CNN process unit. With the above 16×16×3×3 CNN process unit, when there is CNN layer with 20×16×3×3 to be processed, in the traditional way, each set will be divided into two transactions (e.g., 16×16×3×3+4×16×3×3) for a CNN Processing Element (PE) process. In some examples, the second transaction may not have enough data to process the data. This may waste CNN PE resources, which are very costly. In such examples, 4 sets may take 8 cycles to get the 2×2 process completed. With the kernel re-configured, all of the second operations in the 4 sets can fit in the CNN PE to finish in cycle, see, e.g., FIG. 14, rows 16-19 with red color labeled transaction. In this example, the kernel re-configured method may improve (8-5)/8=37.5% performance and power saving.

According to various embodiments, aspects discussed herein may include systems, methods, and devices for image scaling. Various embodiments may receive image data having a channel size and a data size W×H, wherein the image data corresponds to a first resolution, apply a convolutional neural network (CNN) to process the image data according to a set of kernels, generate an interleaved set from the first output set and the second output set, and generate, from the interleaved set, an output image having a second data size, wherein the output image data corresponds to a second resolution. According to various embodiments, instructions to process the image data may include applying, to the image data, a first kernel from the set of kernels to generate a first output set, and applying, to the image data, a second kernel from the set of kernels to the image data to generate a second output set.

In various examples, the first kernel and the second kernel are different. Each kernel within the set of kernels may be independently applied to the input data to generate a plurality of output sets. The output sets may then be interleaved, and ultimately generate the output image.

According to various embodiments, the second resolution may be a multiple of the first resolution. For example, the second resolution may be two, four, six, eight, ten, sixteen, thirty-two, sixty-four, or one hundred and twenty-eight times the first resolution. In some examples, image processing occurs with or without depth-to-space conversion.

The output image may have a second data size of 2 W×2 H. According to various examples, the second data size may be a multiple of the first data size. The set of kernels may comprise two, four, eight, sixteen or other number of kernels. Each kernel may be a unique kernel. The set of kernels may comprise at least one N×N kernel. Each kernel in the set of kernels may be a same or a different size. In some examples, W=H. In other examples, W=4 and H=4.

### B. Efficient Block-Based Convolutional Neural Networks

### DESCRIPTION

Efficient block-based convolutional neural networks are described herein. In one aspect, a method may include representing data as a first matrix including a plurality of elements and having M rows and N columns, where M and N are more than or equal to one. The method may include retrieving, by a CNN, a first element of the plurality of elements. The method may further include processing sequentially, by the first layer of the plurality of layers and a remaining number of layers of the plurality of layers, the first element of the plurality of elements. The method may further include retrieving, by the CNN, a second element of the plurality of elements. The method may further include processing consecutively, by the first layer of the plurality of layers and the remaining number of layers of the plurality of layers, the second element of the plurality of elements. The method may further include outputting, via the CNN, a rendered representation of the data comprising the processed first element and the processed second element.

As mentioned above, efficient block-based convolutional neural networks are described herein. A CNN may include a number of layers that process a data set, for example, an image. Typically, for each layer of a CNN, the data to be processed by the layer is read from external memory, such as DDR memory, is processed by the layer, and is then written to external memory as output. However, as each layer reads from memory the data the layer will process, memory and processing resources for the CNN may increase significantly as the number of CNN layers increase, as well as the size of the original data increases.

Aspects of the present disclosure provide a customized CNN system providing an efficient, customized end-to-end solution. Examples include customized CNN circuit designs providing high performance while using less power and less memory bandwidth than traditional CNNs. It will be understood the methods and apparatuses described in the present application may allow for an elegant solution to minimize processing power and reduce costs associated with multiple back and forth communication between an external memory, a CNN and a processor.

The CNN systems, methods, and devices discussed herein provide significant improvements and efficiencies for image quality improvement, noise reduction operations, and resolution improvements, among others. Rather than executing a routine set of operations for disparate features, and manual analysis, the present disclosure provides real-time, energy-efficient techniques to optimize image operations. For example, the machine learning techniques discussed herein enable optimal kernels to be determined and applied to an image, and generate customized and computationally-efficient scaling operations.

The block-based design of the CNN system efficiently distributes operations to respective processing entities, e.g., pre-processing module, control module, CNN core, and the post-processing module. This unique CNN circuit design results in less power, less memory bandwidth, and higher performance, compared to traditional CNNs. It further eliminates the needs for dedicated circuits for each unique processing operation.

Moreover, the CNN systems provided herein enable dynamic operation and functional testing in a live environment, thereby providing recognition, responses, and solutions to operational and functional issues that may not be recognized or caught during traditional static testing and implementations. In particular, the example systems, methods, devices, and computer program products enable real-time adaptation to dynamically changing environments. Each dedicated system block targets specific functions, while the control module ensures efficient communication and processing between the modules. For example, the CNN core, with its dedicated buffers (e.g., internal, in-place circular buffers), enables specific and customized kernel parameters to be defined, based on the desired scaling operation. The ReLU circuit is further designed to feed layer result(s) back to the in-place circular buffers for additional layer processing, or feed into the post-processing module, where the image information may be delivered, in a desired format, to an output device, such as an external memory.

Previous techniques often required manual testing and/or development of specific tests to process certain image types or color spaces, or to examine and determine various image scaling aspects, such as optimal kernel parameters. However, the present invention provides improved techniques, which may include an automated and/or machine learning-based, comprehensive implementations to analyze image types, color spaces, scaling operations, conversions, and provide dedicated operations to efficiently process each image and standardize operations. The examples and techniques discussed herein significantly improve upon traditional manual or “checklist” based methods, instead analyzing updates from a dynamic, live, and real-time perspective. Such techniques further enable customization and optimization, which may be difficult using traditional methods. In particular, specific dimensions and characteristics may be weighted and/or considered in the dynamic testing and operation techniques.

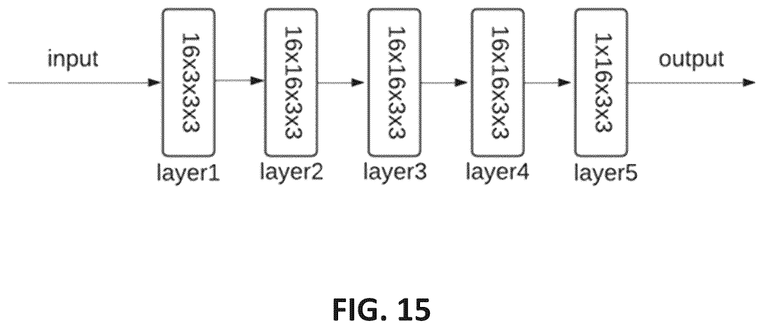

FIG. 15 depicts a representation of a CNN according to the present disclosure. The CNN may include an input layer, an output layer, and one or more intermediate layers. In the CNN of FIG. 15, the intermediate layers are represented by the values P×C×W×H, where P is the output channel number, C is the input channel number, W is the kernel width, and H is the kernel height. Conventional CNNs may include a smaller number of input channels at the input layer and a smaller number of output channels at the output layer. However, conventional CNNs may also include a large number of input and output channels at the intermediate layers. For example, in FIG. 15, the input layer may include 3 input channels and the output layer may include a single output channel. The intermediate layers may each include 16 input channels and 16 output channels. Further, in conventional CNNs, each layer retrieves (e.g., reads) data to be processed by the respective layers, from external memory. Likewise, each layer sends (e.g., writes) to external memory the processed data (e.g., for subsequent processing). Thus, in the example of FIG. 15, the 5 layers depicted of the CNN may read 67 times the original data, and to write 65 times the original data. In the case of the original data being a 4K image, with 24 MB of data, the CNN depicted in FIG. 15 may utilize over 3 GB worth of memory bandwidth.

The processes and systems described herein may significantly reduce memory usage in CNN data processing. According to the present disclosure, a CNN may receive segmented data (or perform the segmentation), which may be for example image data. The CNN may retrieve a segmented portion of the data (e.g., a block) and process the segmented portion through each of the layers of the CNN. The segmented portion may be stored in a circular buffer between layer processing, which may thereby decrease writing the segmented portion back to memory. Further, a sub-portion of the segmented portion may be stored in a circular buffer (e.g., prior to processing by the layers). For a subsequent segmented portion, the CNN may rely on this sub-portion when retrieving the subsequent segmented portion, which may further reduce reding processes from memory.

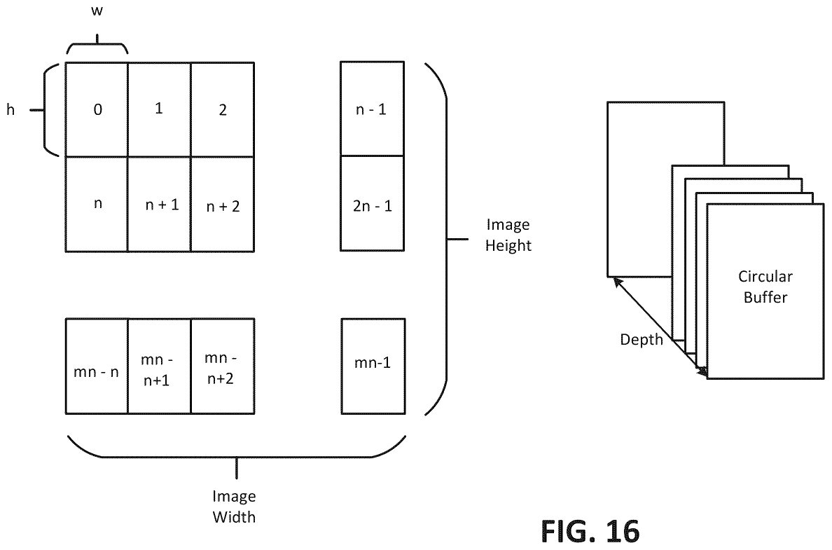

FIG. 16 depicts segmented data for processing by a CNN, according to the present disclosure. The data may be, for example, an image stored in external memory, such as DDR memory. In some cases, the image may be segmented by software dedicated for image segmentation. In some cases, the image may be segmented an input layer of a CNN.

For example, as depicted in FIG. 16, the image data may be segmented into a number of rows and columns, where each row and column contain a number of data blocks. The blocks may include a predetermined height and width, which in some cases may be based on the processing capabilities of the CNN (e.g., number of layers, number of kernels, capabilities of the circular buffer, and the like). In some cases, the size of the data blocks for the image may be uniform throughout, such that one data block has the same dimensions as another data block of the image. In some cases, the image data may be stored in external memory (e.g., DDR) in a segmented format.

The CNN may retrieve less than the total image at a given time. For example, the CNN may be configured to retrieve a first data block of the image data. Retrieval of the first block data may include reading the first block data from the external memory. In some cases, the retrieval may be performed by the circular buffer, which may act as an intermediary storage for the CNN.

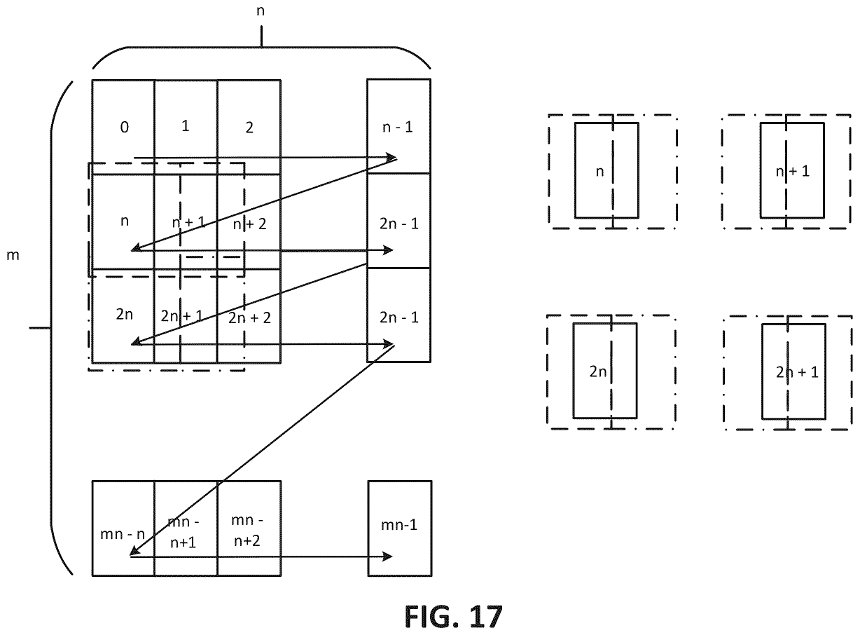

In some cases, the retrieval of the first data block may include retrieving a data amount larger than the first data block. For example, FIG. 17 depicts image data for processing by a CNN according to the present disclosure. The image data may be segmented into data blocks, as described above. In some cases, the CNN may retrieve each data block according to e predefined pattern. For example, the CNN may retrieve the data blocks according to a raster pattern (e.g., as shown by the arrow in FIG. 17). In the example depicted in FIG. 17, the CNN may individually retrieve the data blocks of the first row (beginning with data block “0”), and consecutively process the data blocks through the layers of the CNN.

Beginning at the second row, the CNN may retrieve the data block “n”. In order to retrieve the proper block size for processing, the CNN may retrieve more data than the segmented data block “n”. For example, the CNN may define a fetching block, which may determine the data to be retrieved for processing the data block “n”. The fetching block size may be based on a number of factors. For example, the fetching block size may be based on the size of the data block to be retrieved, the bandwidth of the circular buffer, the processing capabilities of the CNN, the total data of the data image, the number of layers or kernels of the CNN, and the like.

The fetching block may determine the amount of data to be retrieved for retrieval of the data block “n”. The CNN may retrieve the data of the fetching block and place the data in the circular buffer. The data may be processed via the layers of the CNN. For example, the data retrieved in the fetching block may be processed by a first layer of the CNN. The first layer may include one or more kernels or filters, such as convolutional kernels. The one or more kernels may be applied to the data, and the processed data (1st) may be output of the first layer may be placed in the circular. The processed data (1st) may then act as input to a second layer of the CNN, where one or more kernels of the second layer may be applied to the processed data (1st), thereby forming processed layer (2nd). This layer input-kernel application-layer output process may be repeated for each layer of the CNN configured to process the data. In some cases, the output of the last layer for processing the data may be placed in the circular buffer.

The CNN may then initiate processing of another data block for the image data. For example, in the raster scheme depicted in FIG. 17, the CNN may initiate processing for the adjacent data block “n+1”. The CNN may retrieve a portion of the “n+1” data block from external memory, for example, from the segmented data set. The CNN may also retrieve another portion of the “n+1” data block from the circular buffer. For example, the other portion of the “n+1” data block may be stored in the circular buffer after retrieval from external memory for processing of the “n” data block. In some cases, the CNN may parse the other portion of the “n+1” data block from the data stored in the circular buffer for the “n” data block.

The CNN may retrieve the portion of the “n+1” data block from eternal memory similar to the retrieval of the data for processing the “n” data block. For example, a fetching block may identify the particular data to be retrieved for the “n+1” data block. For example, a boundary of the fetching block may align with a boundary of the “n+1” data block stored in the circular buffer (e.g., which may prevent overlap between the portion of data for the “n+1” data block stored in external memory and the portion of data for the “n+1” data block that is stored in the circular buffer). Further, in some cases, the fetching block dimensions may allow for the retrieval of data larger than the “n+1” data block. This retrieved data may be stored in the circular buffer.

The data for the “n+1” data block may be compiled for processing. For example, the portion of the “n+1” data block that was retrieved for the processing of the “n” data block, and the portion of the “n+1” data block that was retrieved for the processing of the “n+1” data block, may be combined to form the dataset for “n+1” processing.

The dataset for the “n+1” may be processed by the layers of the CNN. The processing of the “n+1” dataset may be performed in a fashion similar to the processing of the “n” dataset described above, where the “n+1” dataset is processed by each CNN layer consecutively (e.g., without storing an intermediate layer's processed output in external memory).

Each data block of the dataset stored in external memory may be processed in this fashion. In the case of the dataset being image data, the processing for each data block of a given row or column may occur in similar fashion. For data blocks corresponding to a beginning of a new row or column, processing of that data block may be implemented in a fashion similar to that described for block “n” above (e.g., where the dataset for the given block is retrieved from external memory, and where none of the dataset may be previously stored in the circular buffer). FIG. 17 depicts a process where the data blocks are process row by row, in a raster fashion. Thus, for example, data block “mn-n” may be processed in a fashion similar to that described for block “n” above.

The output of the last CNN, for each data block processed, may be combined to form the processed data. For example, in FIG. 17, the CNN may process each data block 0—“mn−1”. The output of the CNN may be the combined form of the processed data blocks 0—“mn−1”. Combining the processed data blocks may be performed, for example, by a stitching process, and the like.

The processing of each block through the layers of the CNN may occur consecutively, such that the processing output for a data block of a given CNN layer may not be stored in external memory. Instead, the processing output for a data block may either be stored in the circular buffer (e.g., an intermediary storage), or may be sent directly to the next CNN layer as input for processing. This may significantly decrease the need for memory bandwidth of the system. For example, in the case of the CNN of FIG. 15, the 5 layers of the CNN may read 3+(4*16)=67 times the original image to be processed. Further, the CNN may write the image to memory (in processed form) 65 times, meaning the CNN of FIG. 15, when implementing a conventional processing method, may require memory bandwidth that is 132 times the data size of the original image. In contrast, the methods described herein, while utilizing the 5 layers of a CNN having the same input/output characteristics of the CNN of FIG. 1, may read the image data 3 times and write 1 time, meaning the CNN may require memory bandwidth that is 4 times the data size of the original image.

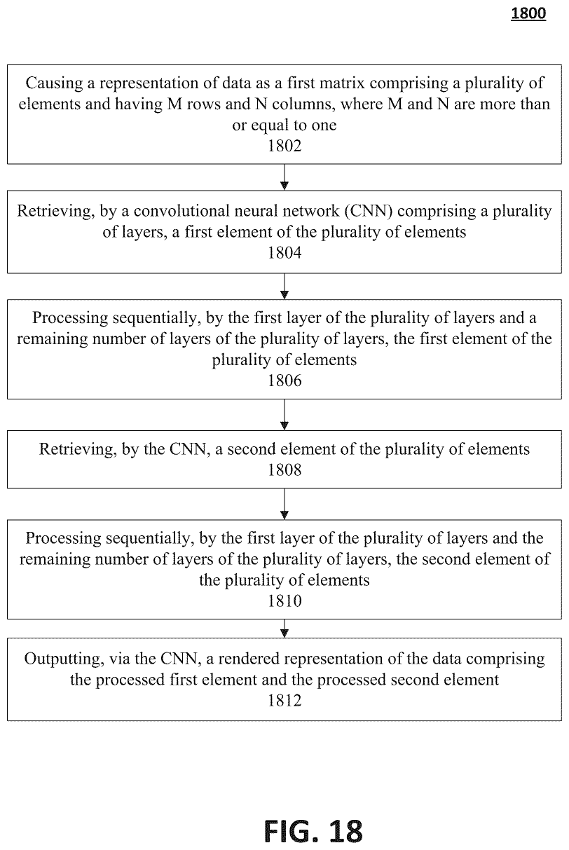

FIG. 18 depicts a process 1800 according to the present disclosure. At Step 1802, a representation of data as a first matrix comprising a plurality of elements and having M rows and N columns may be caused. M and N may be more than or equal to one. At Step 1804, a CNN comprising a plurality of layers may retrieve a first element of the plurality of elements. In some cases, retrieving the first element may include retrieving an overlapping data portion of the data, where the overlapping data portion includes data of another element of the plurality of elements. At Step 1806, the first layer of the plurality of layers and a remaining number of layers of the plurality of layers, may process sequentially the first element of the plurality of elements. In some cases, a portion of the first element may be stored in a circular buffer.

At Step 1808, the CNN may retrieve a second element of the plurality of elements. In some cases, retrieving the second element may include retrieving a first portion of the second element in the circular buffer, and retrieving a second portion of the second element from external memory. At Step 1810, the first layer of the plurality of layers and the remaining number of layers of the plurality of layers, may process sequentially the second element of the plurality of elements. At Step 1812, the CNN may output a rendered representation of the data comprising the processed first element and the processed second element.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method for image scaling, comprising:
receiving image data having a channel size and a data size W×H, wherein the image data corresponds to a first resolution;
applying a convolutional neural network (CNN) to process the image data according to a set of kernels, wherein the instructions to process the image data comprise:
applying, to the image data, a first kernel from the set of kernels to generate a first output set; and
applying, to the image data, a second kernel from the set of kernels to the image data to generate a second output set,
generating an interleaved set from the first output set and the second output set; and
generating, from the interleaved set, an output image having a second data size, wherein the output image data corresponds to a second resolution.

2. The method of claim 1, wherein the first kernel and the second kernel are different.

3. The method of claim 1, wherein the second resolution is a multiple of the first resolution.

4. The method of claim 3, wherein the multiple is two.

5. The method of claim 1, wherein processing the image data occurs without depth-to-space conversion.

6. The method of claim 1, wherein the second data size is 2 W×2 H.

7. The method of claim 1, wherein the set of kernels comprise four unique kernels.

8. The method of claim 1, wherein the channel size is sixteen.

9. The method of claim 1, wherein W=4 and H=4.

10. The method of claim 1, wherein the set of kernels comprise at least one N×N kernel.

11. A system for image scaling, comprising:
a processor; and
a memory comprising instructions which cause the processor to:
receive image data having a channel size and a data size W×H, wherein the image data corresponds to a first resolution;
apply a convolutional neural network (CNN) to process the image data according to a set of kernels, wherein the instructions to process the image data comprise:
apply, to the image data, a first kernel from the set of kernels to generate a first output set; and
apply, to the image data, a second kernel from the set of kernels to the image data to generate a second output set;
generate an interleaved set from the first output set and the second output set; and
generate, from the interleaved set, an output image having a second data size, wherein the output image data corresponds to a second resolution.

12. The system of claim 11, wherein the first kernel and the second kernel are different.

13. The system of claim 11, wherein the second resolution is a multiple of the first resolution.

14. The system of claim 13, wherein the multiple is two.

15. A non-transitory computer readable medium comprising instructions stored thereon, which, when executed by a processor, causes a computing system to:
receive image data having a channel size and a data size W×H, wherein the image data corresponds to a first resolution;
apply a convolutional neural network (CNN) to process the image data according to a set of kernels, wherein the instructions to process the image data comprise:
apply, to the image data, a first kernel from the set of kernels to generate a first output set; and
apply, to the image data, a second kernel from the set of kernels to the image data to generate a second output set;
generate an interleaved set from the first output set and the second output set; and
generate, from the interleaved set, an output image having a second data size, wherein the output image data corresponds to a second resolution.
